(19) United States
(12) Patent Application Publication
(10) Pub. No.: US 2023/0208753 A1
(43) Pub. Date: Jun. 29, 2023

(54) COMMUNICATION SYSTEM, COMMUNICATION PATH SWITCHING METHOD, COMMUNICATION DEVICE, AND PROGRAM

(71) Applicant: NIPPON TELEGRAPH AND TELEPHONE CORPORATION, Tokyo (JP)

(72) Inventors: Keisuke YAMAGATA, Musashino-shi, Tokyo (JP); Shinichi YOSHIHARA, Musashino-shi, Tokyo (JP); Hideo KAWATA, Musashino-shi, Tokyo (JP)

(73) Assignee: NIPPON TELEGRAPH AND TELEPHONE CORPORATION, Tokyo (JP)

(21) Appl. No.: 17/926,867

(22) PCT Filed: May 26, 2020
(86) PCT No.: PCT/JP2020/020696

§ 371 Date: Nov. 21, 2022

(51) Int. Cl. H04L 45/28; H04L 45/00

(52) U.S. Cl. CPC H04L 45/28; H04L 45/22

(57) ABSTRACT

An object of the present disclosure is to provide a communication system, a communication path switching method, a communication device, and a program capable of continuing communication or shortening a communication disconnection time even during an operation of switching paths.

A communication system according to the present disclosure is a communication system including two communication devices forming a duplex path with a common access network. A first communication device out of the two communication devices converts an ordinary packet that has not been transferred to the access network into a relief packet obtained by adding a predetermined mark to the ordinary packet and transfers the relief packet to a second communication device out of the two communication devices when the first communication device detects a failure in a communication path with the access network, and the second communication device receives the relief packet from the first communication device, then converts the relief packet into an ordinary packet, and transmits the converted ordinary packet to the access network.

### TECHNICAL FIELD

The present disclosure relates to switching between access device duplex paths in a network.

### BACKGROUND ART

In the related art, in a case where an access link failure occurs in access device duplex paths in a network, for example, an access device connected to the link detects the failure and transmits a control packet, whereby the other access device path in the duplex paths is thus released, the path is switched to the device, and communication is recovered. Unfortunately, communication disconnection occurs during processing from failure occurrence to path switching, and communication disconnection also occurs in a case where a maintenance person switches the paths, not due to a failure.

### CITATION LIST

### Patent Literature

PTL 1: JP 2009-194622 A

### SUMMARY OF THE INVENTION

### Technical Problem

An object of the present disclosure is to provide a communication system, a communication path switching method, a communication device, and a program capable of continuing communication or shortening a communication disconnection time even during an operation of switching paths.

### Means for Solving the Problem

According to the present disclosure, in a case in which a device constituting an access device duplex path detects a failure, in parallel with path switching in the related art, the device adds a relief flag to a packet directed to the device and transfers the packet as a relief packet to an access pair that is one of a pair of the duplication. The device of the one of the pair of the duplication receives the relief packet, then deletes the relief flag, and transmits the packet to an access link. In this manner, communication can be maintained with the relief packet even during the path switching according to the related art. Consequently communication is not disconnected, or a communication disconnection time is shortened.

Specifically, a communication system according to the present disclosure is a communication system including two communication devices forming a duplex path with a common access network. A first communication device out of the two communication devices converts an ordinary packet that has not been transferred to the access network into a relief packet obtained by adding a predetermined mark to the ordinary packet and transfers the relief packet to a second communication device of the two communication devices, when the first communication device detects a failure in a communication path with the access network, and the second communication device receives the relief packet from the first communication device, then converts the relief packet into an ordinary packet, and transmits the converted ordinary packet to the access network.

Specifically, a communication path switching method according to the present disclosure is a communication path switching method that is executed by a communication system including two communication devices forming a duplex path with a common access network. The method includes by a first communication device out of the two communication devices, converting an ordinary packet that has not been transferred to the access network into a relief packet obtained by adding a predetermined mark to the ordinary packet and transferring the relief packet to a second communication device out of the two communication devices when the first communication device detects a failure in a communication path with the access network, and by the second communication device, receiving the relief packet from the first communication device, then converting the relief packet into an ordinary packet, and transmitting the converted ordinary packet to the access network.

Specifically, a communication device according to the present disclosure is a communication device that is one of two communication devices forming a duplex path with an access network, the communication device including: an access port that is connected to the access network and transmits and receives a packet; a port other than the access port, the port being connected to a paired device that is the other one of the two communication devices and transmitting and receiving a packet; a packet transfer unit that performs packet transfer processing; an ordinary packet relief transfer unit that performs relief processing for an ordinary packet that has not been transferred to the access network, by using failure information, paired device information, and network information that are held by the communication device when a failure in the duplex path is detected; a relief packet flag addition unit that converts the relieved ordinary packet into a relief packet obtained by adding a predetermined mark to the ordinary packet; a pair determination unit that determines the relief packet transferred from the paired device and transferrers the relief packet to an access port side; and a relief packet flag deletion unit that converts the relief packet transferred from the paired device into an ordinary packet before relief.

Specifically, a program according to the present disclosure is a program for realizing a computer as functional units included in the communication device according to the present disclosure, and for causing the computer to execute each step included in the communication method executed by the communication device according to the present disclosure.

### Effects of the Invention

According to the present disclosure, paths can be switched without communication disconnection or with a communication disconnection time shortened.

### BRIEF DESCRIPTION OF DRAWINGS

FIG. 1 illustrates an operation example in the related art in a case where a failure occurs in duplex paths.

FIG. 2 illustrates an example of switching paths in an access network in a case of applying the present disclosure.

FIG. 3 illustrates an example of a network configuration according to the present disclosure.

FIG. 4 illustrates a first configuration example of a packet transfer device according to the present disclosure.

FIG. 5 illustrates an example of packet processing according to the present disclosure.

FIG. 6 illustrates an example of ordinary packet processing and relief packet processing.

FIG. 7 illustrates an example of ordinary packet processing.

FIG. 8 illustrates an example of relief packet processing.

FIG. 9 illustrates a second configuration example of a packet transfer device according to the present disclosure.

FIG. 10 illustrates an example of checking of a connection port of an access redundancy pair.

FIG. 11 illustrates an example of a relief operation after the connection port of the access redundancy pair is checked.

FIG. 12 illustrates a third configuration example of the packet transfer device according to the present disclosure.

FIG. 13 illustrates an example of a method of checking an address of a paired device of the access redundancy pair.

FIG. 14 illustrates an example of a relief operation after checking the address of the paired device of the access redundancy pair.

FIG. 15 illustrates a fourth configuration example of the packet transfer device according to the present disclosure.

### DESCRIPTION OF EMBODIMENTS

Hereinafter, embodiments of the present disclosure will be described in detail with reference to the drawings. Further, the present disclosure is not limited to the embodiments described below. These examples of the embodiments are merely examples, and the present disclosure can be implemented in forms in which various modifications and improvements are added based on knowledge of those skilled in the art. Constituent elements with the same reference signs in the specification and the drawings are assumed to be the same constituent elements.

### Related Art

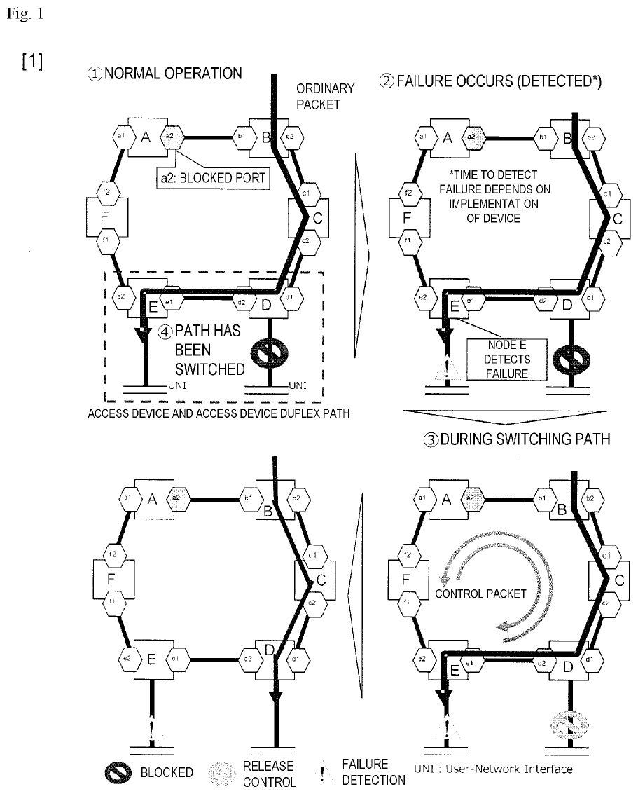

A switching example of paths in an access network using the related art will be described with reference to FIG. 1. Nodes D and E are connected to a user-network interface (UNI), and this constitutes access devices and access device duplex paths. In FIG. 1, the following operations are performed in a case in which a failure occurs in the access device duplex paths. Although a ring network is illustrated as one network configuration example at a location other than the access devices and the access device duplex paths in the present disclosure, it is possible to employ any network configuration in the present disclosure.

(1) At normal times, an ordinary packet is input from a node B and is then output from the node E through a node C and the node D. An a2 port of a node A connected to the node B is blocked.
(2) The node E connected to a link where a failure has occurred detects the failure.
(3) The node E transmits a control packet.
(4) The access device duplex path on the side of the node D is released. The node D receives the control packet, and the path is then switched.

### Overview of Present Disclosure

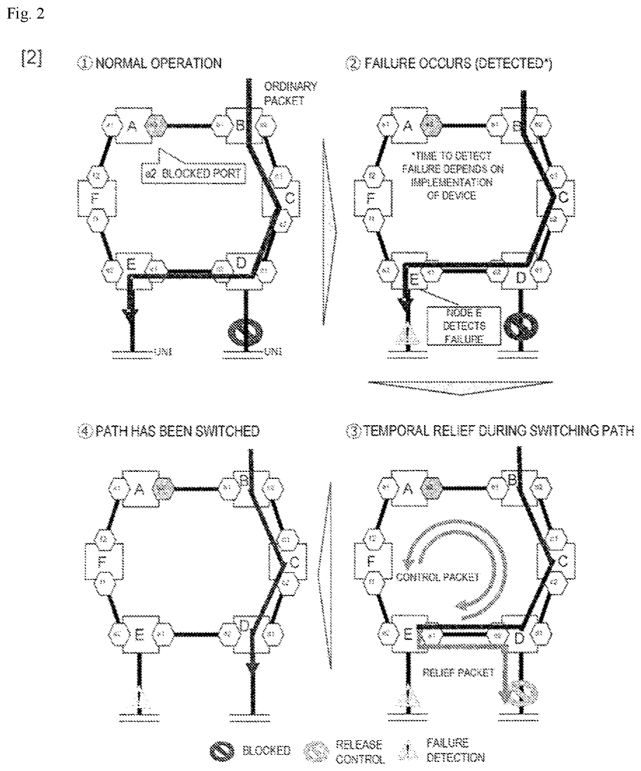

An example of switching of paths in an access network using the technique in the present disclosure will be described with reference to FIG. 2. According to the present disclosure, in a case in which a failure occurs in access device duplex paths, a failure detection node determines whether to relieve an ordinary packet and temporarily relieves the ordinary packet in parallel with switching an access device path. That is, a relief packet is transferred.

However, in this case, it is assumed that the nodes (D and E) recognize that the nodes (D and E) each have an access device duplex path and can be distinguished from other device pairs having an access device duplex path. Hereinafter, an access device redundancy pair will be referred to as an “access redundancy pair”. Each device of the access redundancy pair will be referred to as “own device and paired devices”.

The present disclosure makes it possible to shorten a time of communication disconnection due to path switching from the occurrence of a failure to the detection, using a relief packet in a case in which the failure occurs in access device duplex paths. Also, in a case in which the access device duplex path is switched as scheduled, according to the present disclosure, the path can be switched without communication disconnection.

### System Configuration

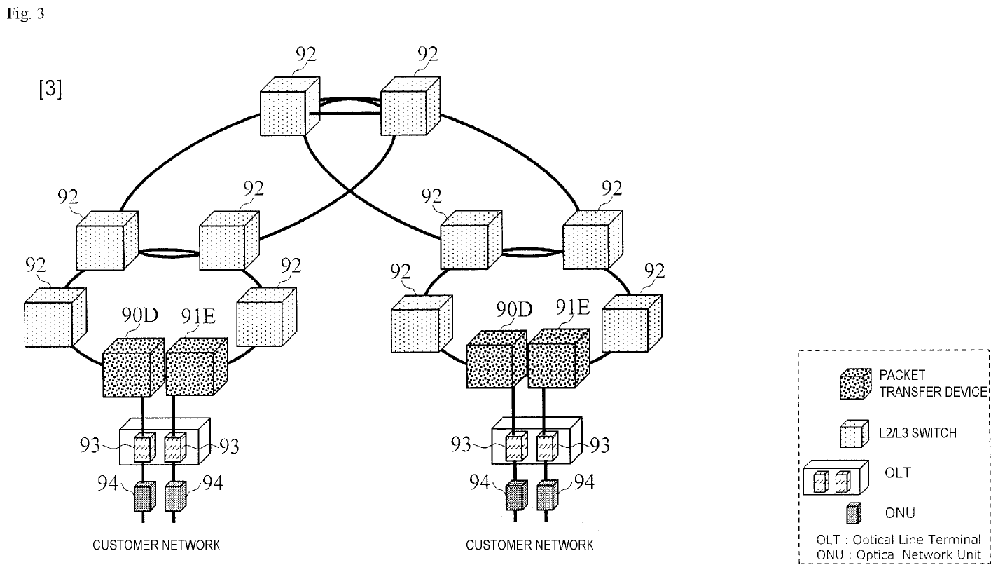

FIG. 3 illustrates an example of a network configuration according to the present disclosure. The communication device according to the present disclosure are paired devices and are, for example, packet transfer devices 91D and 91E each connected between an L2 or L3 switch 92 and an OLT 93. The packet transfer devices 91D and 91E correspond to the nodes D and E illustrated in FIG. 2. The packet transfer devices 91D and 91E are each connected to an access network including the OLT 93 and an ONU 94 and function as access devices forming duplex paths. FIG. 3 illustrates a ring network as one network configuration example other than the access devices and access device duplex paths, and the paired devices are assumed to be adjacent to each other.

The packet transfer devices 91D and 91E according to the present disclosure can also be operated by computers and programs, and the programs can be recorded in recording media and provided through a network. The same applies to the following embodiments.

### First Embodiment

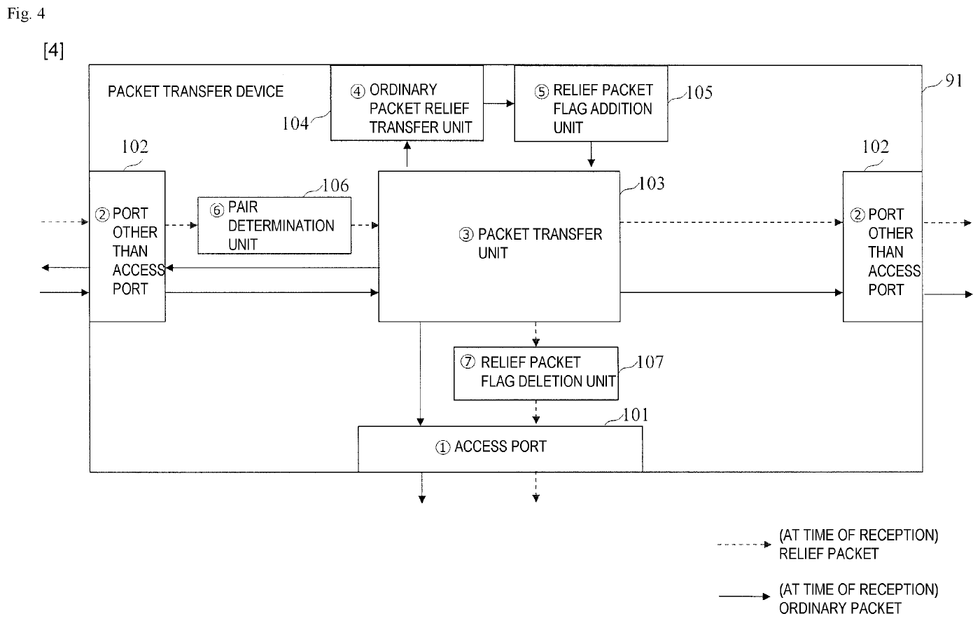

FIG. 4 illustrates a first configuration example of the packet transfer device according to the present disclosure. The packet transfer device 91 according to the present embodiment is a communication device forming an access device duplex path. The packet transfer device 91 includes: an access port 101 that transmits and receives a packet; a port 102 other than the access port that transmits and receives a packet; a packet transfer unit 103 that transfers a packet; an ordinary packet relief transfer unit 104 that performs relief processing in the packet transfer device by using failure information, access redundancy pair information, and network information which are held by the packet transfer device 91 when a failure is detected in the access device duplex path; a relief packet flag addition unit 105 that converts a packet into a temporary packet; a pair determination unit 106 that determines a packet transferred from a paired device and transfers the packet to an access port side; and a relief packet flag deletion unit 107 that converts the relief packet into a packet before relief.

The port 102 is, for example, a ring port forming a ring network illustrated in FIG. 2.

In the present disclosure, a packet received by a node is read to determine relief in the access device duplex paths. For example, the ordinary packet relief transfer unit 104 determines an ordinary packet that cannot be transferred to the access network using the failure information held by the communication device.

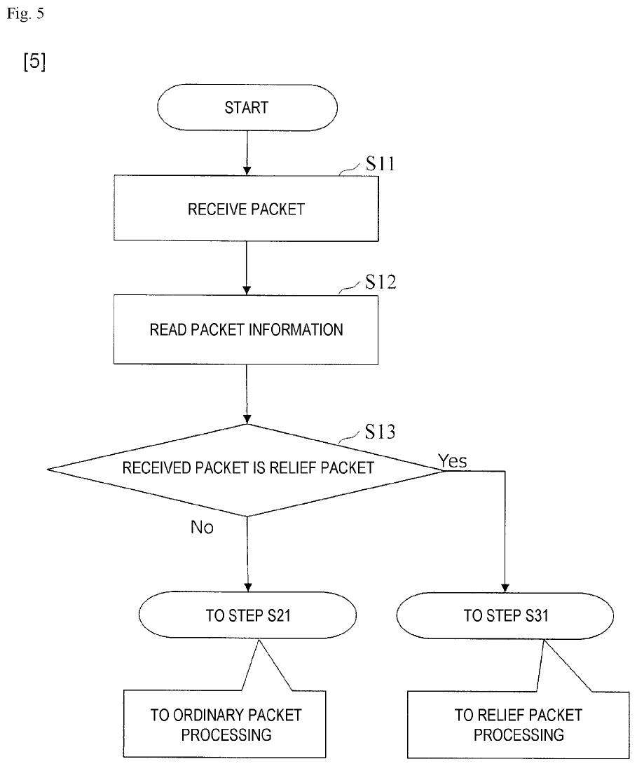

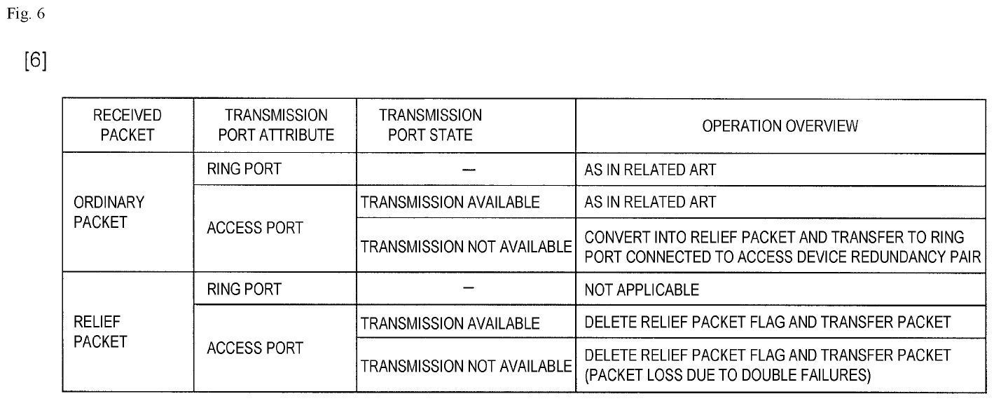

FIG. 5 illustrates an example of packet processing according to the present disclosure. The packet transfer device 91 receives a packet (S11), reads packet information from the received packet (S12), and determines whether the received packet is a relief packet (S13). In a case in which the received packet is not a relief packet (No in S13), the packet transfer device 91 executes ordinary packet processing. In a case in which the received packet is a relief packet (Yes in S13), the packet transfer device 91 executes relief packet processing. FIG. 6 illustrates an example of the ordinary packet processing and the relief packet processing. A determination flow for packet transfer depends on the received packet, a transmission port attribute, and a transmission port state.

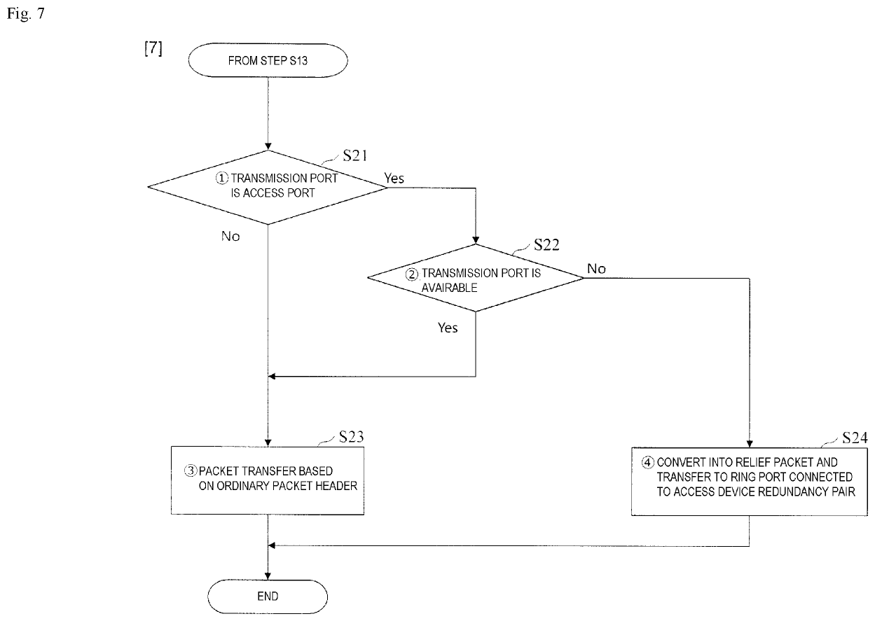

FIG. 7 illustrates an example of the ordinary packet processing.
In a case in which the transmission port is not an access port (No in S21), packet transfer based on an ordinary packet header is performed (S23).
In a case in which the transmission port is an access port (Yes in S21) and the transmission port can perform transmission (Yes in S22), packet transfer based on the ordinary packet header is performed (S23).
In a case in which the transmission port is an access port (Yes in S21) and the transmission port is not available for transmission (No in S22), the packet is converted into a relief packet, and the relief packet is transferred to the port 102 connected to the access device redundancy pair in accordance with the access redundancy pair information and the network information (S24).

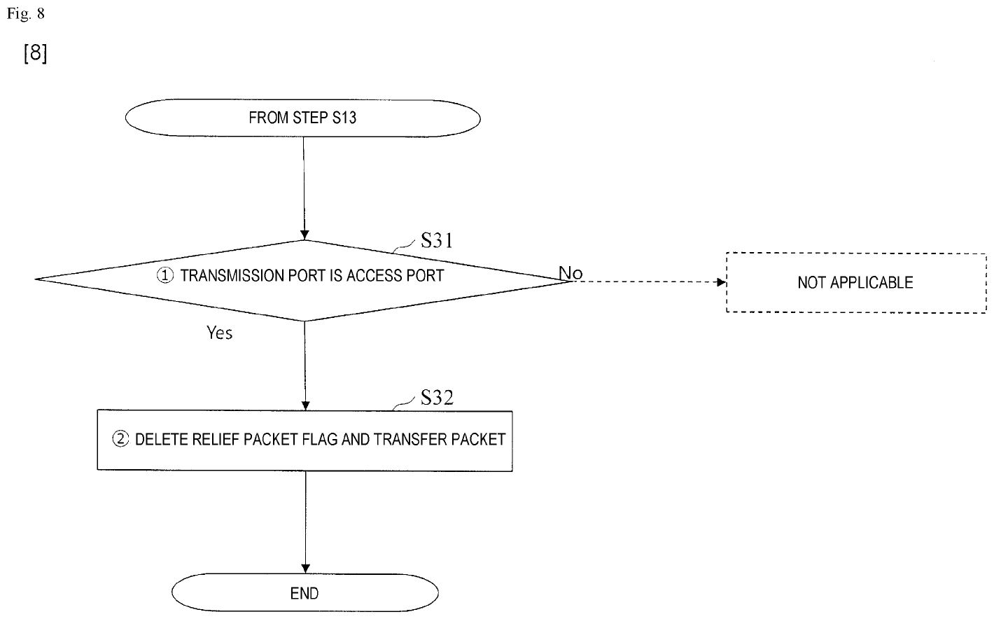

FIG. 8 illustrates an example of the relief packet processing.
In a case in which the transmission port is an access port (Yes in S31), the relief packet flag is deleted, and the packet is then transferred (S32).

Operation examples of the nodes D and E in a case in which a failure has been detected in the node E in the ring network illustrated in FIG. 2 will be described. An ordinary packet is input to the port 102 (d1 illustrated in FIG. 2), and the packet transfer unit 103 sends the ordinary packet to the port 102 (d2 illustrated in FIG. 2). The ordinary packet is transferred to the port 102 (e1 illustrated in FIG. 2) of the node E.

The ordinary packet is input from the port 102 (e1 illustrated in FIG. 2). The ordinary packet is transferred to the packet transfer unit 103, transferred to the ordinary packet relief transfer unit 104, then transferred to the relief packet flag addition unit 105, and converted into a relief packet to which a predetermined mark indicating that the packet is a relief packet is added. For example, the predetermined mark may be a value for a relief packet, added to a frame type, a packet service type, or the like. The relief packet is transferred to the packet transfer unit 103, then transferred to the port 102 (e1 illustrated in FIG. 2), and returned. The relief packet output from the port 102 is transferred to the node D and then returned.

The relief packet is input from the node E to the node D. The relief packet is input from the port 102 (d2 illustrated in FIG. 2). The pair determination unit 106 determines that the relief packet input from the node E is a packet transferred from the paired device and transfers the relief packet to the packet transfer unit 103. The packet transfer unit 103 transfers the relief packet to the relief packet flag deletion unit 107. The relief packet flag deletion unit 107 converts the relief packet into a packet before relief and outputs the packet to the access port 101. The packet before relief is transmitted from the access port 101.

The present disclosure makes it possible to shorten a time of communication disconnection due to switching a path by using the relief packet in a case in which a failure occurs in an access device duplex path. The present disclosure makes it possible to switch the paths without communication disconnection in a case in which access switching is performed as scheduled.

### Second Embodiment

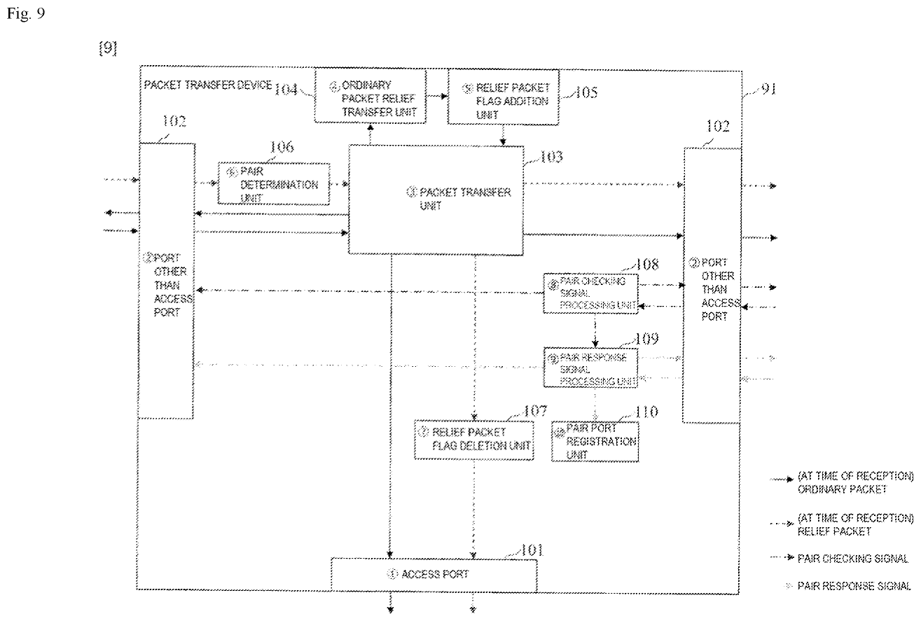

FIG. 9 illustrates a second configuration example of the packet transfer device according to the present disclosure. The packet transfer device 91 according to the present embodiment does not register therein in advance, information regarding to which port of the own device the paired device is connected in advance.

The packet transfer device 91 according to the present embodiment is a communication device including functional units included in the packet transfer device 91 according to the first embodiment, a pair checking signal processing unit 108, a pair response signal processing unit 109, and a pair port registration unit 110, and also including a means for registering, therein in advance, information regarding to which port of the own device the paired device is connected before a failure occurs in the access device duplex path.

The pair checking signal processing unit 108 transmits a signal for checking the paired device (hereinafter, a pair checking signal) from all ports 102 other than the access port of the own device.

In a case in which the pair checking signal is received from the paired device of the device, the pair response signal processing unit 109 transmits a signal (hereinafter, a pair response signal) to the paired device.

The pair port registration unit 110 registers information regarding to which port the paired device is connected (from which port the pair response signal has been received). The packet transfer device 91 according to the present embodiment includes a pair port registration unit 110 and registers therein information regarding to which port of the device the paired device is connected before a failure occurs in the access device duplex path.

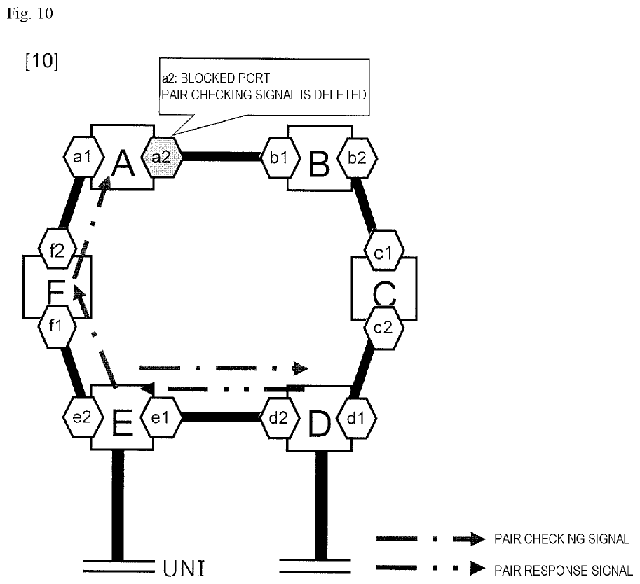

FIG. 10 illustrates an example of checking a connection port of an access redundancy pair. As an example, a case in which the node E checks a connection port of the node D will be described. It is assumed that the nodes (D and E) recognize that the nodes (D and E) each have an access device duplex path and can be distinguished from other device pairs having an access device duplex path. On this assumption, two methods will be described below in which the nodes (D and E) determine ports to which its access redundancy pair device is connected will be described below.
At the time of initial setting of the access redundancy pair, paired device information (a connection port and the like) is registered in each packet transfer device 91.
Each packet transfer device 91 of the access redundancy pair transmits a signal for checking the paired device (pair checking signal) from both ports 102. In a case in which the pair checking signal is transmitted from the paired device of the packet transfer device 91 that has received the pair checking signal, the packet transfer device 91 transmits a signal (pair response signal) to the paired device. For example, because the node E has received a pair response signal at the e1 port, for example, the node E recognizes that the node D that is the paired device is adjacent to the e1 port. Here, it is assumed that the pair checking signal cannot pass through a blocked port. In a case in which the pair checking signal is not transmitted from the paired device of the own device, the packet transfer device 91 transfers the pair checking signal from the port 102 other than the port at which the pair checking signal has been received.

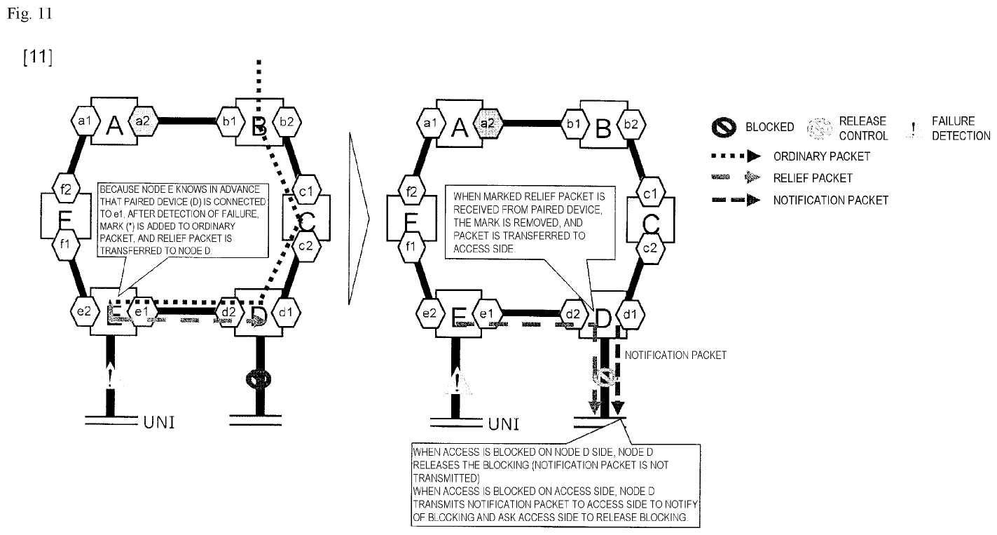

FIG. 11 illustrates an example of relief operations after checking the connection port of the access redundancy pair. As one example, an example in which the node E transfers a relief packet to the node D will be described. It is assumed that the nodes (D and E) recognize that the nodes (D and E) each have an access device duplex path and can be distinguished from other device pairs having an access device duplex path. In addition, it is assumed that the access redundancy pairs are adjacent to each other and know in advance to which port the paired device is connected to.

In a case in which a failure is detected on an access side of the access redundancy pairs, all following ordinary packets to be transferred to the access side are converted into relief packets and are then transferred to the paired device. For example, because the node E knows in advance that the paired device (node D) is connected to the port e1, the node E adds a mark to the ordinary packet and transfers the relief packet to the node D after detection of the failure. For example, as the mark to determine that the packet is a relief packet, a value for the relief packet may be added to a frame type, a packet service type, or the like.

In a case in which the relief packet is received from the paired device, the mark is removed from the packet, and then the packet is transferred to the access side. In a case in which a relief packet with a mark is received from the node E which is its paired device, for example, the node D removes the mark of the relief packet from the packet and transfers the packet to the access side. However, an access between the node D and UNI is blocked, the blocking is released before the packet is transmitted.

Although any method can be used to release the blocking, the following two patterns can be used for example.
In a case in which an access redundancy pair is blocked, the node releases the blocking.
In a case in which the access side is blocked, a notification packet is transmitted to the access side from the access redundancy pair to notify the access side of the blocking and ask the access side to release the blocking.

In a case in which the access is blocked on the node D side, for example, the node D releases the blocking. In this case, the node D does not transmit the notification packet. In addition, in a case in which the access is blocked on the access side, the node D transmits the notification packet to the access side to notify the access side of the blocking and asks the access side to release the blocking.

### Third Embodiment

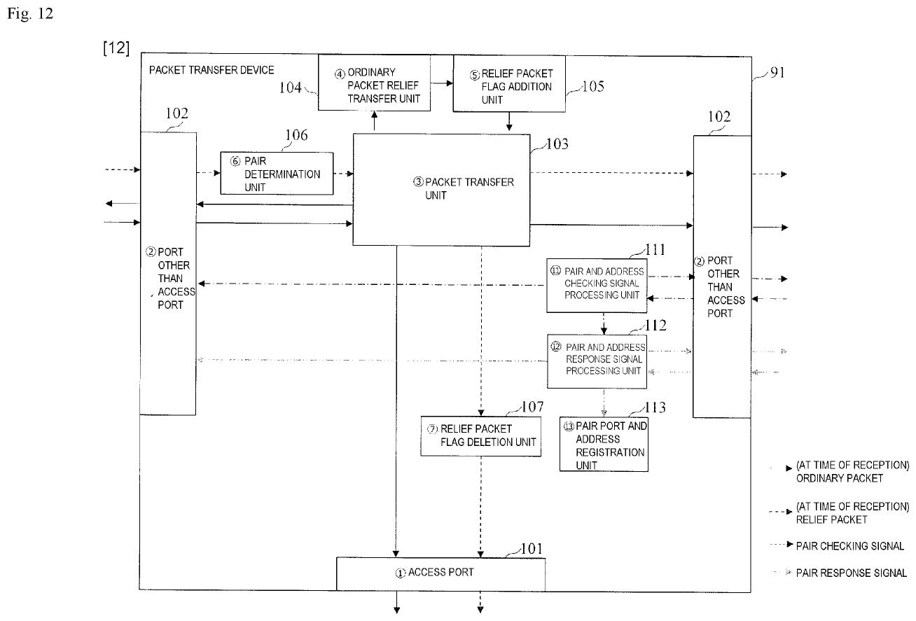

FIG. 12 illustrates a third configuration example of the packet transfer device according to the present disclosure. The packet transfer device 91 according to the present embodiment does not register, therein in advance, information regarding where the paired device is connected on the network.

The packet transfer device 91 according to the present embodiment is a communication device including a pair and address checking signal processing unit 111, a pair and address response signal processing unit 112, and a pair port and address registration unit 113 and also including a means for registering, in the own device, where the paired device is connected on the network before a failure occurs in the access device duplex path.

The pair and address checking signal processing unit 111 transmits a signal for checking the paired device (hereinafter, a pair and address checking signal) from all ports 102 other than the access port of the own device.

In a case in which the pair and address response signal processing unit 112 receives the pair and address checking signal from the paired device of the own device, the pair and address response signal processing unit 112 transmits a signal (hereinafter, a pair and address response signal) to the paired device.

The pair port and address registration unit 113 registers which port is communicating with the paired device and which address is connected to the paired device.

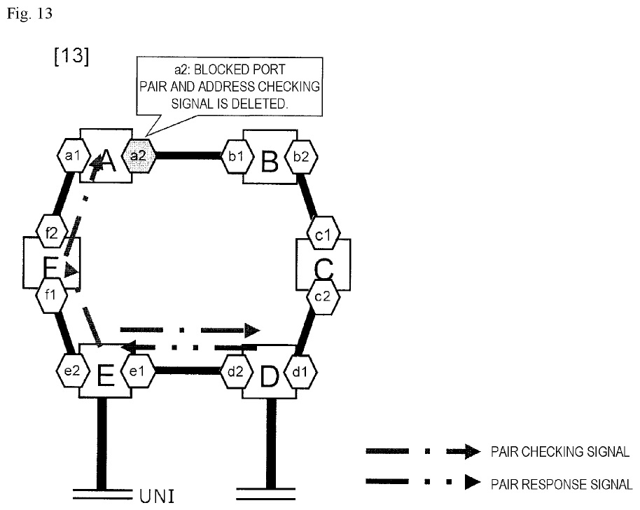

FIG. 13 illustrates an example of a method of checking a paired device address of the access redundancy pair. As one example, a case in which the node E checks the device address of the node D will be described. It is assumed that the nodes (D and E) recognize that the nodes (D and E) each have an access device duplex path and can be distinguished from other device pairs having an access device duplex path. On this assumption, each of the nodes (D and E) determines which port is communicating with the access redundancy pair device of the own device and to which addresses the pair device is connected. Two determination methods will be described below.
At the time of initial setting of the access redundancy pair, paired device information (a communication port, an address, and the like) is registered in each packet transfer device 91.
A signal for checking the paired device (hereinafter, a pair and address checking signal) is transmitted from both ports 102 of the access redundancy pair device. In a case in which the pair and address checking signal has been transmitted from the paired device of the device that has received the signal, the device transmits a signal (hereinafter, a pair and address response signal) to the paired device. In a case in which the node E receives the pair response signal at the e1 port, for example, the node E recognizes that the node E is communicating with the node D which is the paired device on the e1 port side, and obtains the address of the node D.

It is assumed that the pair and address checking signal cannot pass through a blocked port. In a case in which the pair and address checking signal is not transmitted from the paired device of the own device, the pair checking signal is transferred from a port other than the port at which the signal has been received.

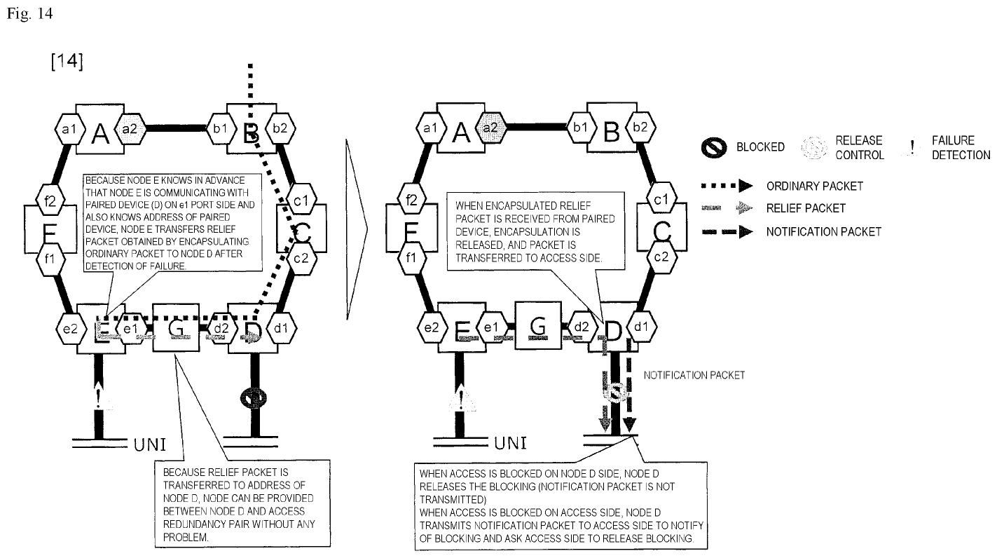

FIG. 14 illustrates an example of a relief operation after checking the address of the paired device of the access redundancy pair. As an example, a case in which the node E transfers a relief packet to the node D will be described. It is assumed that the nodes (D and E) recognize that the nodes (D and E) each have an access device duplex path and can be distinguished from other device pairs having an access device duplex path. In this assumption, the nodes (D and E) know in advance which port is communicating with the paired device and which address is connected to the paired device. Note that the access redundancy pair is not necessarily adjacent to each other.

In a case in which a failure is detected on the access side of the access redundancy pair, all the following ordinary packets to be transferred to the access side are transferred to the paired device as encapsulated relief packets. For example, because the node E knows in advance that the node E is communicating with the paired device (node D) on the e1 port side and also knows the address of the paired device, the node E transfers the relief packet obtained by encapsulating an ordinary packet to the node D after detection of a failure. Because the relief packet is transferred to the address of the node D, any node can be provided between the node D and the access redundancy pair without any problem.

In a case in which a relief packet directed to the node E is received from the paired device, the encapsulation is released, and the packet is then transferred to the access side. However, an access between the node D and UNI is blocked, the blocking is released before the packet is transmitted. Although any method can be used to release the blocking, the following two patterns can be used for example.
In a case in which an access redundancy pair is blocked, the node releases the blocking.
In a case in which the access side is blocked, a notification packet is transmitted to the access side from the access redundancy pair to notify the access side of the blocking and ask the access side to release the blocking.

In a case in which an encapsulated relief packet is received from the paired device, for example, the encapsulation is released, and the packet is then transferred to the access side. In a case in which the access is blocked on the node D side, the node D releases the blocking. That is, the notification packet is not transmitted. In a case in which the access is blocked on the access side, the node D transmits the notification packet to the access side to notify the access side of the blocking and asks the access side to release the blocking.

### Fourth Embodiment

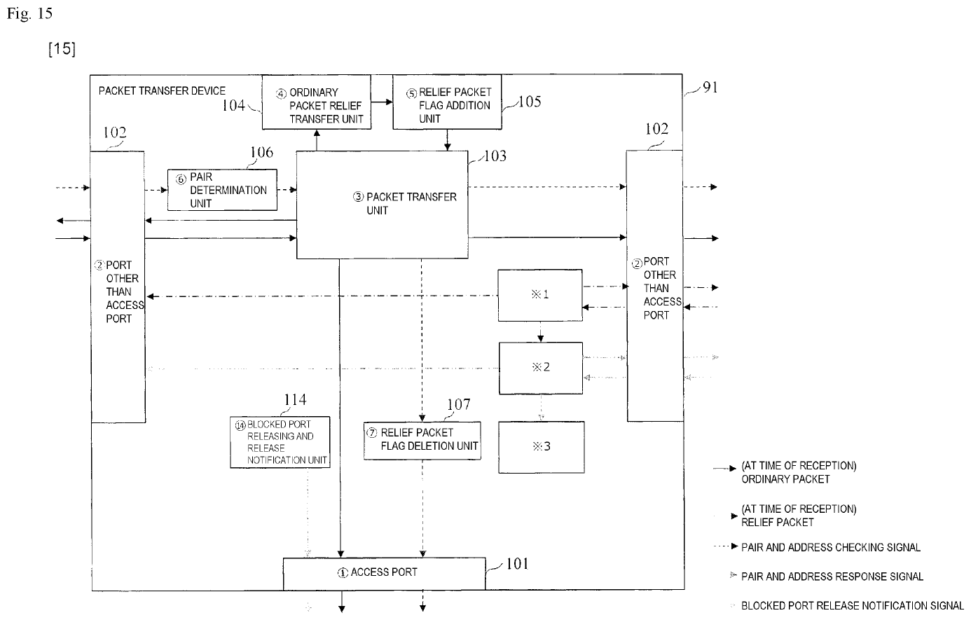

FIG. 15 illustrates a fourth configuration example of the packet transfer device according to the present disclosure. The packet transfer device 91 according to the present embodiment is a communication device including a blocked port releasing and release notification unit 114 and also including a means for switching the access device duplex path and a means for preventing a packet loss by transferring a packet to the blocked port, in the packet transfer device according to the first, second, or third embodiment, In a case in which the packet transfer device 91 blocks the access, the blocked port releasing and release notification unit 114 releases the blocked port before transferring a relief packet to the access port when the relief packet is received from the paired device. In a case in which the access is blocked on the access side, the blocked port releasing and release notification unit 114 provides a notification to the access side to release the blocked port.

Combinations of *1, *2, and *3 in FIG. 15 are the following three patterns.

A: None (first embodiment)
B: The pair checking signal processing unit 108, the pair response signal processing unit 109, and the pair port registration unit 110 (second embodiment)
C: The pair and address checking signal processing unit 111, the pair and address response signal processing unit 112, and the pair port and address registration unit 113 (third embodiment)

In the present embodiment, the pair checking signal processing unit 108, the pair response signal processing unit 109, and the pair port registration unit 110 may be included as in the second embodiment. In this case, the blocked port releasing and release notification unit 114 releases the blocked port after the pair port registration unit 110 registers the port to which the paired device is connected.

In the present embodiment, the pair and address checking signal processing unit 111, the pair and address response signal processing unit 112, and the pair port and address registration unit 113 may be included as in the third embodiment. In this case, the blocked port releasing and release notification unit 114 releases the blocked port after the pair port and address registration unit 113 registers the port to which the paired device is connected and the address of the paired device.

### INDUSTRIAL APPLICABILITY

The present disclosure can be applied to information and communication industries.

### REFERENCE SIGNS LIST

91 Packet transfer device 92 L2/L3 switch
93 OLT
94 ONU
101 Access port
102 Port other than access port
103 Packet transfer unit
104 Ordinary packet relief transfer unit
105 Relief packet flag addition unit
106 Pair determination unit
107 Relief packet flag deletion unit
108 Pair checking signal processing unit
109 Pair response signal processing unit
110 Pair port registration unit
111 Pair and address checking signal processing unit
112 Pair and address response signal processing unit
113 Pair port and address registration unit
114 Blocked port releasing and release notification unit

1. A communication system including two communication devices forming a duplex path with a common access network,
wherein a first communication device out of the two communication devices converts an ordinary packet that has not been transferred to the access network into a relief packet obtained by adding a predetermined mark to the ordinary packet and transfers the relief packet to a second communication device out of the two communication devices when the first communication device detects a failure in a communication path with the access network, and
the second communication device receives the relief packet from the first communication device, then converts the relief packet into an ordinary packet, and transmits the converted ordinary packet to the access network.

2. A communication path switching method that is executed by a communication system including two communication devices forming a duplex path with a common access network, the method comprising:
by a first communication device out of the two communication devices, converting an ordinary packet that has not been transferred to the access network into a relief packet obtained by adding a predetermined mark to the ordinary packet and transferring the relief packet to a second communication device out of the two communication devices when the first communication device detects a failure in a communication path with the access network, and
by the second communication device, receiving the relief packet from the first communication device, then converting the relief packet into an ordinary packet, and transmitting the converted ordinary packet to the access network.

3. A communication device that is one of two communication devices forming a duplex path with an access network, the communication device comprising:
an access port connected to the access network and configured to transmit and receive a packet;
a port other than the access port configured to transmit and receive a packet, the port being connected to a paired device that is another one of the two communication devices;
a packet transfer unit configured to perform packet transfer processing;
an ordinary packet relief transfer unit configured to perform relief processing for an ordinary packet that has not been transferred to the access network, by using failure information, information regarding the paired device, and network information which are held by the communication device when a failure is detected in the duplex path;
a relief packet flag addition unit configured to convert the relieved ordinary packet into a relief packet obtained by adding a predetermined mark to the ordinary packet;
a pair determination unit configured to determine the relief packet transferred from the paired device and transfer the relief packet to an access port side; and
a relief packet flag deletion unit configured to convert the relief packet transferred from the paired device into the ordinary packet before relief.

4. The communication device according to claim 3, further comprising:
a pair checking signal processing unit configured to transmit a signal for checking a paired device from all ports, other than the access port, of the communication device in a case in which information regarding to which port of the communication device the paired device is connected is not registered in the communication device in advance, the signal being referred to as a pair checking signal;
a pair response signal processing unit configured to transmit a signal referred to as a pair response signal to the paired device in a case in which the pair checking signal is received from the paired device of the communication device; and
a pair port registration unit configured to register information regarding which port the paired device is connected to, in accordance with which port the pair response signal is received from.

5. The communication device according to claim 3,
further comprising:
a pair and address checking signal processing unit configured to transmit a signal for checking a paired device from all ports, other than the access port, of the communication device in a case in which information regarding where the paired device is connected on the network is not registered in the communication device in advance, the signal being referred to as a pair and address checking signal;
a pair and address response signal processing unit configured to transmit a signal referred to as a pair and address response signal to the paired device in a case in which the pair and address checking signal is received from the paired device of the communication device; and
a pair port and address registration unit configured to register information regarding which port is communicating with the paired device and which address is connected to the paired device.

6. The communication device according to claim 3, further comprising
a blocked port releasing and release notification unit configured to release a blocked port before the relief packet is transferred to the access port or notify an access side to ask to release the blocked port in a case in which the relief packet is received from the paired device.

7. A non-transitory computer-readable medium having computer-executable instructions that, upon execution of the instructions by a processor of a computer, cause the computer to function as the communication device according to claim 3.
